(19) United States
(12) Patent Application Publication
(10) Pub. No.: US 2021/0235789 A1
(43) Pub. Date: Aug. 5, 2021

(54) MASK-ON-A-STICK

(71) Applicant: Brian Michael Coyle, Canyon, CA (US)

(72) Inventors: Brian Michael Coyle, Canyon, CA (US); Alys Larsen, Canyon, CA (US)

(21) Appl. No.: 17/237,053

(22) Filed: Apr. 22, 2021

(51) Int. Cl. A41D 13/11

(52) U.S. Cl. CPC A41D 13/1107

(57) ABSTRACT

A mask-on-a-stick includes a holding part and a mask unit which are connected, in which the mask unit has a curved shape. When a user is holding the mask-on-a-stick, the mask unit fits naturally over their mouth and lower nose, and the mask unit surface prevents the user from spreading microbial particles to the environment. The widest part of the mask unit fits over the user's mouth, and above this area the mask unit extends to cover the lower nose. The mask-on-a-stick can be manufactured from cellulose-based material at reasonable cost, so as to be disposable, or recyclable after sterilizing, and numerous sizes of the mask-on-a-stick may be made available for customers at restaurants and other locations where people remove facemasks to eat or drink, but need to cover their mouth and nose when talking.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### CROSS-REFERENCE TO RELATED APPLICATIONS

This application claims the benefit of U.S. Non-Provisional Design patent application Ser. No. 29/777,272, filed on Apr. 7, 2021, which is incorporated herein in its entirety.

### FIELD OF THE INVENTION

The invention relates generally to a disease-prevention device which is practical, decorative, and conveniently protects persons who cannot wear a facemask because of they are engaged in physical activity such as eating and drinking. More particularly, the invention relates to a mask-on-a-stick providing practical, simple, and attractive prevention of disease transmission in facilities such as restaurants, schools, or places of worship.

### BACKGROUND OF THE INVENTION

In today's society restaurants are very popular for socializing and business communications. People visit these establishments to eat and drink, activities that a facemask physically impedes. Beside eating and drinking, people in these establishments engage in talking, sometimes loudly, and laugh. If a person is infected with a microbe that has respiratory transmission, engaging in these activities risks emitting microbial particles that remain airborne, the reason people are supposed to wear facemasks. During the COVID-19 pandemic, and in other similar pandemics, restaurants are vectors of disease transmission, especially during periods when disease prevalence has reduced. Also, people who have been vaccinated against viral diseases may have the illusion that they cannot be infected and transmit, but no viral vaccine generates sterilizing immunity. Because restaurants can be crowded, people speak at louder volumes, and emitted microbes concentrate, compounding the problem of preventing disease transmission.

Those who manage restaurant-type establishments need them to remain open, but do not want them to be vectors of transmission.

Although eating and drinking provide common reasons for people to remove facemasks, there are other activities in which participants tend to not wear facemasks but may engage in talking and singing that may transmit disease. Some people do not wear facemasks when they are in church services. Many microbial diseases do not have high rates of respiratory transmission from ordinary breathing, but talking and singing can emit ten times or more the amount of microbial particles. These are the activities implicated in many public transmissions of SARS CoV-2.

School children in elementary, middle, and high schools have different transmission patterns than adults, for many diseases. In the case of SARS Cov-2, they may transmit less, but transmit asymptotically. In the case of influenza disease, children transmit more, and others may not be aware of it. If children do not wear masks when sitting in classrooms, they may primarily transmit when speaking.

The present invention provides an aesthetically pleasing, convenient, and practical means of preventing disease transmission by people engaged in activities in which they do not wear facemasks. Prior art describes means to prevent respiratory disease transmission by attaching a facemask to the head or body of the wearer. There is no prior art that addresses respiratory disease transmission prevention by people who do not have a device attached to their head or body.

Accordingly, it is a principle object of the present invention to provide a mask-on-a-stick for use by a person for preventing respiratory disease transmission when they engage in transmission-likely activities while not wearing a facemask.

### BRIEF DESCRIPTION OF THE DRAWINGS

In view of these and other objects which will become more readily apparent as the nature of the invention is better understood, the invention consists in the novel combination and arrangement of parts hereinafter more fully described, illustrated and claimed with reference being made to the appended drawings in which:

FIG. 1 is a perspective view of a preferred embodiment of a mask-on-a-stick shown from the side that faces away from a user;

FIG. 2 is a perspective view of a preferred embodiment of a mask-on-a-stick shown from the side that faces towards a user;

FIG. 3 is a perspective view of a preferred embodiment of a mask-on-a-stick for a smaller person;

FIG. 4 is a perspective view of a preferred embodiment of a mask-on-a-stick for a larger person;

FIG. 5 is a schematic view of a mask unit with an outer framework;

FIG. 6 is a schematic view of a mask unit with an expanding and contracting framework;

FIG. 7 is a top plan view of a mask-on-a-stick positioned in a place setting;

FIG. 8 is a perspective view of multiple masks-on-a-stick in a centerpiece.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the term “facemask” is defined as respirator, surgical mask, cloth face covering, or other protective mask covering the nose and mouth that is attached to a user with ear loops, extensions that go around the head, attachments to an article of clothing, or other means of support. Specific dimensions and other physical characteristics relating to the embodiments disclosed herein are not to be considered as limiting, unless the claims expressly state otherwise.

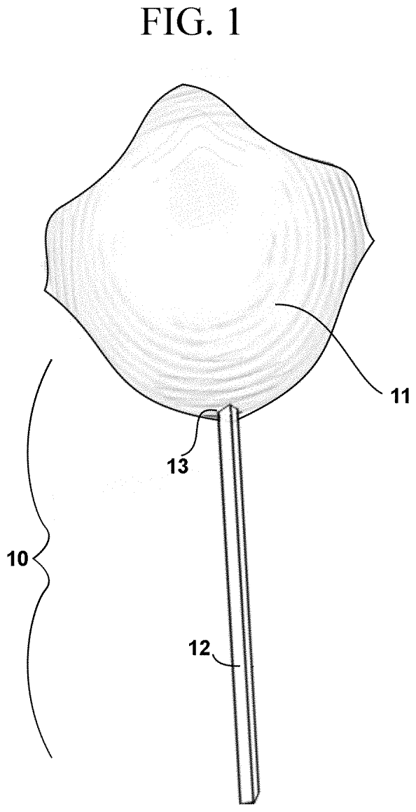

Referring now to FIG. 1, a mask-on-a-stick 10 according to the invention, seen from the side that faces away from the user, includes a mask unit 11 intended to cover the nose and mouth of a user, securely fastened at one end to the extension member 12 with upper end 13 securely fastened the base of the mask unit 11. The mask unit 11 and the extension member 12 are formed to the desired aesthetic appearance of the design of the mask-on-a-stick 10. An upper portion 14 of the mask unit 11 is sized so that its top edge 15 will cover the lower part of the user's nose, when the wide portion 16 covers the user's mouth.

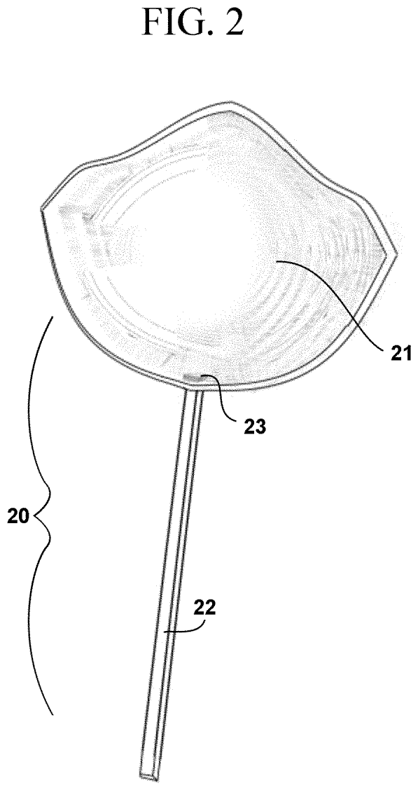

Referring now to FIG. 2, the mask-on-a-stick 20 according to the invention is seen from the side that faces towards a user. The internal side of mask unit 21 is concave, and shaped to cover the nose and mouth of a user, securely fastened at one end to the extension member 22 with upper end 23 securely fastened the base of the mask unit 21.

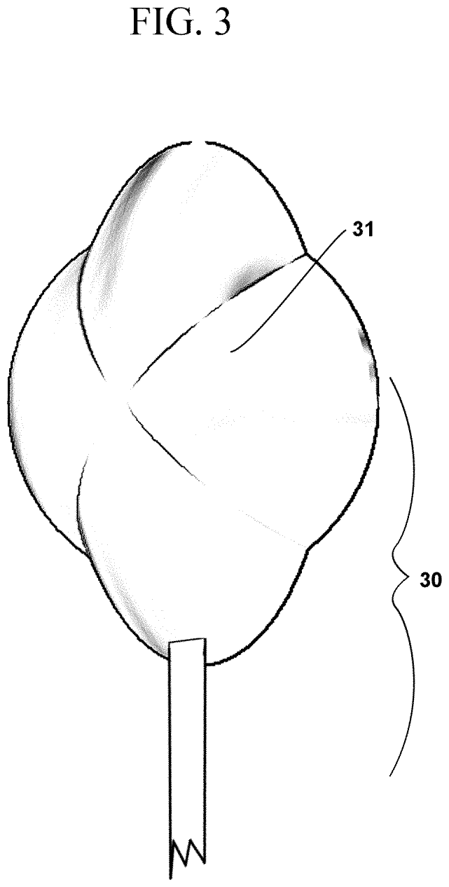

Referring now to FIG. 3, an embodiment of a mask-on-a-stick 30 according to the invention illustrates a small sized mask unit 31, intended to cover the nose and mouth of a user with a smaller face, such as an adolescent.

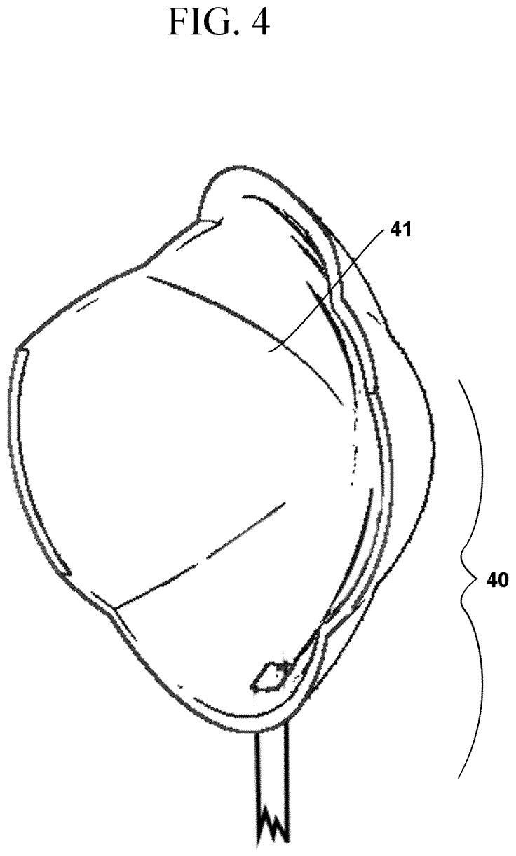

Referring now to FIG. 4, an embodiment of a mask-on-a-stick 40 according to the invention illustrates a large sized mask unit 41, intended to cover the nose and mouth of a user with a larger face.

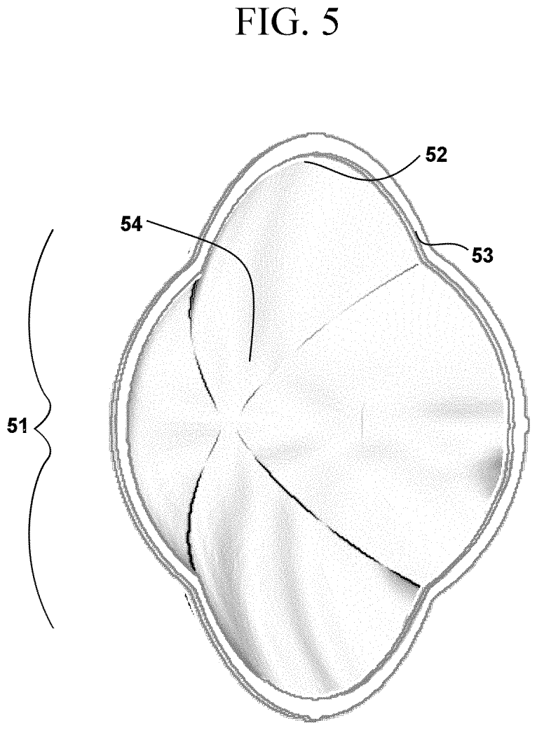

Referring now to FIG. 5, an embodiment of a mask-on-a-stick 50 according to the invention illustrates a mask unit 51 with perimeter 52 comprising a framework 53 to support protective element 54 that covers the user's nose, mouth, and chin areas. Substantially ovoid framework 53 is substantially rigid and is attached to substantially flexible protective element 54. Although one having skill in the art can further segment or adopt a non-ovoid configuration for framework 53, the substantially ovoid framework 53 provides a shape that conveniently fits over most people's noses, mouths, and chins.

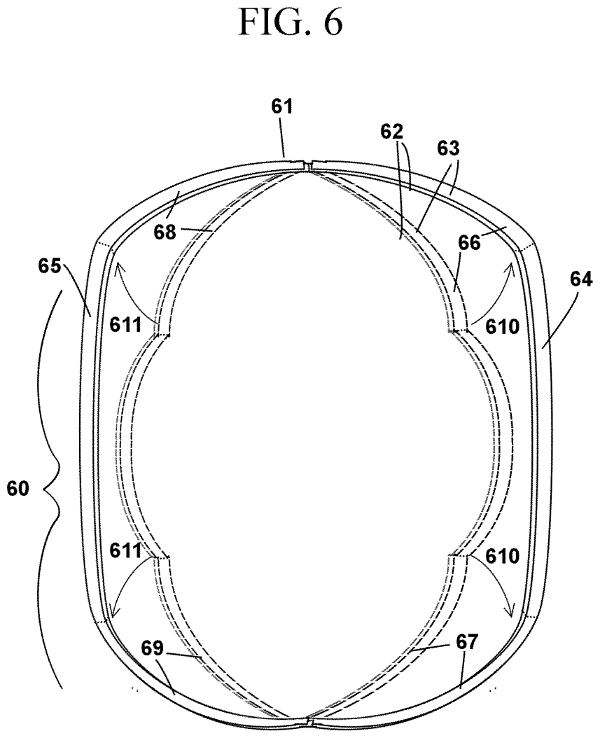

Referring now to FIG. 6, an embodiment of a mask-on-a-stick 60 according to the invention illustrates a mask unit 61 with perimeter 62 comprising a segmented framework 63 such that side segments 64 and 65 may be grasped and pushed away from the mask unit center, which causes top and bottom segments 66, 67, 68, and 69 to lift away from a longitudinal center-line as shown in arrows 610 and 611, to provide increased lateral protection for the user.

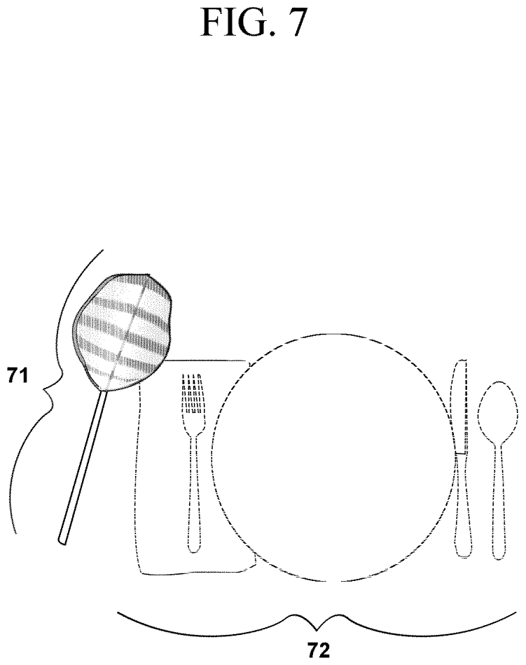

Referring now to FIG. 7, the mask-on-a-stick 71 is shown in a top view, as it may be presented at a restaurant, in a place-setting 72 for customers. In presenting the mask-on-a-stick 71, the device is preferably decorated with designs that encourage interest in it, and make it attractive to use. The designs can display a logo, trade dress, products of the restaurant, or imagery. The type and style of the designs on the mask-on-a-stick are limitless.

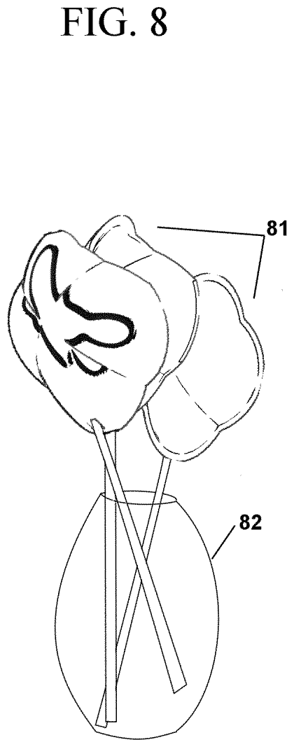

Referring now to FIG. 8, multiple masks-on-a-stick 81 are shown standing upright in a centerpiece 82 which may be assembled from florist foam, a basket, or a vase, as non-limiting examples.

In conclusion, herein is presented a mask-on-a-stick device that covers a user's nose and mouth when they hold it, for use in a restaurant or other context where users cannot wear a regular facemask. The invention is illustrated by example in the drawing figures, and throughout the written description. It should be understood that numerous variations are possible, while adhering to the inventive concept. Such variations are contemplated as being a part of the present invention.

1. A mask-on-a-stick, comprising:
a holding part extending in a longitudinal direction to be held by a user;
a mask unit including a curved shell for preventing microbial transmission;
the curved shell having a size sufficient to fit over the mouth and lower nose of the user;
the holding part connected to the mask unit to form the mask-on-a-stick;
the mask-on-a-stick being used by a person who does not wear a facemask;
the person holds the mask-on-a-stick in front of their mouth and nose when they talk, sing, or otherwise may emit infectious particles;
the mask-on-a-stick may be set aside by the user.

2. The device of claim 1, wherein the mask unit is of a size that fits over the mouth and lower nose of a child.

3. The device of claim 1, wherein the mask unit is formed of flexible materials, so that the user can optimally adjust the size and shape of the mask unit.

4. The device of claim 1, wherein the mask unit is formed of an adjustable structure, so that the user can optimally adjust the size and shape of the mask unit.

5. The device of claim 1, wherein the holding part is independently formed and then attached to the mask unit.

6. The device of claim 1, wherein the mask-unit is impregnated with one or more disinfectants.

7. The device of claim 1, wherein the mask-unit is impregnated with one or more odorants.

8. The device of claim 1, wherein the mask-unit is made of a biodegradable single-use material.

9. The device of claim 1, wherein the mask-unit is made of a recyclable material.

10. The device of claim 1, wherein the mask-unit is made of a material that may be cleaned and reused.

11. The device of claim 1, wherein a design on the mask-unit surface is selected from the group consisting of a logo, a picture, a drawing, one or more phrases, a list, a recipe, one or more numbers, and one or more symbols.

12. A method of manufacture of a mask-on-a-stick, comprising:
a) providing a mask-unit of a semi-rigid material, having a portion that covers a user's mouth, and a portion that covers the user's nose, the mask-unit having a curved shape, with an internal and external side, the internal concave side facing the user, the external convex side facing away from the user, at least one extension projects below the mask-unit; and
b) forming a mask-on-a-stick by connecting the extension to the mask-unit, the extension being dimensioned for the user to hold in their hand, and the mask-unit being dimensioned to fit over the nose and mouth of the user.
